(19) United States
(12) Patent Application Publication
(10) Pub. No.: US 2004/0165709 A1
(43) Pub. Date: Aug. 26, 2004

(54) Stealth interception of calls within a VoIP network

(76) Inventors: Robert Leslie Pence, Plano, TX (US); Satish Gundabathula, Irving, TX (US)

Correspondence Address: Enucleo Technologies, Inc., 5100 Singing Brook Rd., Flower Mound, TX, 75028, US

(21) Appl. No.: 10/378,106

(22) Filed: Feb. 24, 2003

(51) Int. Cl. H04M 3/42

(52) U.S. Cl. 379/201.01; 379/213.01

(57) ABSTRACT

Stealth interception of calls within a VoIP Network (91) for providing law enforcement related call interception capability (60,61,62). The VoIP network comprises of basically a SoftSwitch (20) that offers IP based telephony services for subscribers (10, 11) over a packet network. Packet Interceptors (51) are deployed in a packet network to non-intrusively monitor the signaling (21) and media packets (22), which comprise a call in a VoIP Network. The Call Monitoring Engine (50) on receipt of an intercept request from the Law Enforcement Agency (40); notifies the packet interceptors to monitor for packets and the Voice Packet Receiver and Assembler (52) for reception of voice packets. On detection of relevant packets the interceptors inform the Call Monitoring Engine of signaling packets and the Voice Packet Receiver and Assembler of voice packets. This packet information is processed and transmitted (41,42) to the Law Enforcement Agency.

### FIELD OF THE INVENTION

The present invention relates to providing a surveillance mechanism for Law Enforcement for VoIP based Soft Switches without the intervention of the Soft Switch or the Access Device.

### BACKGROUND OF THE INVENTION

Law Enforcement Authorities are permitted to legally monitor and intercept telephone calls made by individuals in an investigation. With the advent of technology and the growth of IP based telephony networks, it has become necessary for Telecom Service Providers to provide the above-mentioned capability for Law Enforcement Authorities over IP based networks. The Communication Assistance for Law Enforcement Act of 1994 requires that all United States based communication service providers provide the capability of legally intercepting calls made in their network. The Federal Communication Commission (FCC) governs the CALEA implementation. These regulations are completely specified in the interim standard J-STD-025.

The present invention provides the mechanism for telecom communication providers to adhere to the regulations of FCC by providing a solution of legally intercepting calls made over a VoIP based network.

### SUMMARY OF THE INVENTION

Stealth Interception of telephone calls in a VoIP network is achieved by the invention using Call Monitoring Engine Software, associated with a set of Packet Interceptors. The Packet Interceptors inspect the network for activity associated with VoIP traffic. The LEA on request for monitoring a specific telephone, issues a request to the Call Monitoring Engine, which sets up a state machine to govern the flow and control of the call being monitored. Commands are issued to the Packet Interceptors, to monitor for packets associated with the monitored party.

The Packet Interceptors forward signaling information to the Call Monitoring Engine to drive the state machine and call flow and the voice data is sent to the Voice Packet Receiver and Assembler for buffering and forwarding onto the LEA.

### BRIEF DESCRIPTON OF THE DRAWINGS

FIG. 1 is a block diagram illustrating a network overview of the deployed components with reference to the present invention.

FIG. 2 is a call flow diagram illustrating a mechanism of the surveillance performed by the present invention.

### DETAILED DESCRIPTON

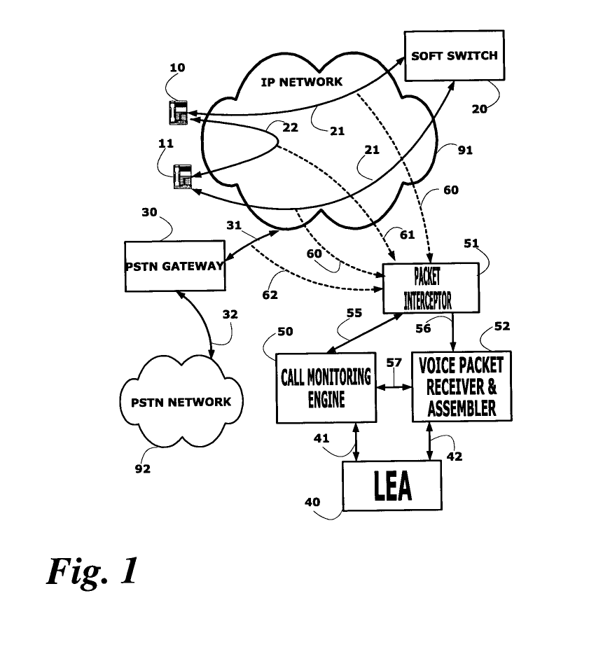

Packet Interceptors 51 is shown, in the FIG. 1, as connected to a VoIP network 91. The telephony devices 10, 11 are also connected to a part of the VoIP network. The Call Monitoring Engine 50, the Voice Packet Receiver and Assembler 52 are also part of the stealth surveillance network isolated from the VoIP network. The Law Enforcement Agency 40 is connected to the stealth surveillance network via a secure link 41, 42. The Soft switch 20 is part of the VoIP network, which enables the telephony devices to communicate. The PSTN gateway 30 allows the VoIP telephony devices to be able to access the PSTN network 92 and vice versa.

The present invention provides the CALEA capability for Soft Switches 20 and Access Devices 10, 11 deployed in a VoIP based network 91. The present invention provides a non-intrusive method, independent of the Soft Switch or the deployed Access Devices. The core network consists of an IP based network; with deployed IP based Access devices being controlled by an IP based Soft Switch.

The components of the present invention include the Call Monitoring Engine 50, which controls all requests from the Law Enforcement Agencies 40 for request to intercept and monitor the activities of involved parties. The Packet Interceptors 51 are the non-intrusive components that plug into the IP based network monitoring for packets complying with the standard VoIP signaling (SIP, MGCP, H.323, Megaco) and media protocols (RTP). The Voice Packet Receiver & Assembler Component (VPRA) 52 buffers and re-transmits the media stream over to the requesting LEA. The present invention uses a secure link to communicate to and from the LEA.

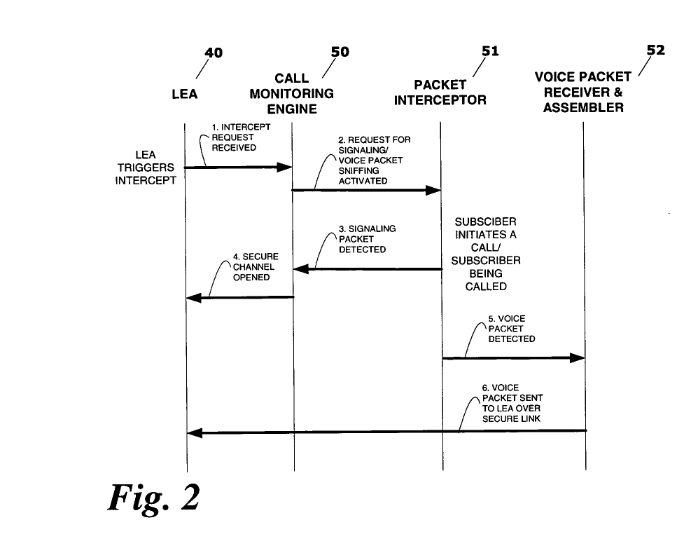

The stealth surveillance as the invention describes, is shown in the FIG. 2, and is triggered by a request from the LEA 40. The request to monitor a telephony device in the VoIP network is routed to the Call Monitoring Engine (CME) 50. The Packet Interceptors 51 are notified of the request to monitor any activity on the VoIP network for the telephony device in contention. The Packet Interceptors isolate and filter packets based on the standard VoIP signaling protocols (SIP, MGCP, H.323, Megaco). On initiation of surveillance by the Call Monitoring Engine, a Session is created in the CME's context to keep track of the surveillance state. The session constitutes a state machine encapsulating the call flow of the signaling between the monitored telephony device and any other device it is interacting with in the VoIP network.

The state machine identifies the various states of the duration of the call and also supports multiple protocols. The state machine drives and correlates the information received from the Packet Interceptors. The state machine also identifies and triggers the detection of voice activity. The Packet Interceptors on receipt of the Voice Detected Command from the State machine in the Call Monitoring Engine, forwards voice packets to the Voice Packet Receiver and Assembler, which buffers and forwards the voice data to the LEA over a secure channel.

On call termination, the state machine in the Call Monitoring Engine then instructs the Packet Interceptors to clear and end the surveillance session. Transmission to the LEA is also terminated as a result.

What is claimed is:

1. A surveillance system, comprising:
A VoIP telephony device including all identification and a means to communicate with other VoIP telephony devices in a VoIP network, or a non-VoIP device using an access gateway.
Packet interceptors for monitoring packet activity on the said VoIP network.
Call Monitoring Engine equipped with a VoIP call Flow state machine, to be contacted by the Law Enforcement agencies via a secure channel.
Voice Packet Receiver and Assembler that buffers and forwards voice data to the LEA over a secure channel.

2. The surveillance system according to claim 1, wherein said VoIP network comprises a packet based network.

3. The surveillance system according to claim 2, wherein said VoIP network includes a SoftSwitch signaling unit.

4. The surveillance system according to claim 3, wherein said Softswitch unit controls the operation of the telephony device according to claim 1.

5. The surveillance system according to claim 1, wherein said VoIP network is capable of connecting and interoperating with a non-VoIP network like a PSTN network.

6. A method for providing stealth surveillance between a VoIP telephony device and other VoIP or non-VoIP based telephony devices over a VoIP network, said method comprising:
receive surveillance request from the Law Enforcement Agency to monitor a telephony device.
initiating a state machine to drive the call flow of the monitored telephony device.
interceptors are triggered on reception of packets originating and terminating at the telephony device.
intercept voice packets as a result of the call, information for voice packets are collected during signaling packet capture.
intercepted voice packets are assembled and sent to the LEA over a secure channel.
call interception is achieved without the involvement of the Soft Switch or the Access Device, during the duration of the call; surveillance is done in stealth mode.

7. The method according claim 6, further comprising the step of obtaining provisioned information of the telephony device.

8. The method according claim 6, wherein the step of utilizing a state machine to handle surveillance, is capable of supporting multiple VoIP protocols; different VoIP protocols can be mixed in a single state machine graph.

9. The method according claim 6, wherein said VoIP network comprises a packet-based network.

10. The method according claim 6, further comprising the step of being able to deliver the voice data to one or more LEAs.

11. A method for providing stealth surveillance in a VoIP based network, said method comprising:
a dedicated packet network isolated from the VoIP based network.
access ports on the VoIP based network for locating packet interceptors.
Communication within the surveillance network is packet based.

12. The stealth surveillance system according to claim 11, where in said communication means comprises a direct communications link.

13. The stealth surveillance system according to claim 11, where in said access ports means a packet based access port.
